(19) United States
(12) Patent Application Publication
(10) Pub. No.: US 2006/0234098 A1
(43) Pub. Date: Oct. 19, 2006

(54) Direct carbon fuel cell with molten anode

(75) Inventor: Turgut M. Gur, Palo-Alto, CA (US)

Correspondence Address: LUMEN INTELLECTUAL PROPERTY SERVICES, INC., 2345 YALE STREET, 2ND FLOOR, PALO ALTO, CA, 94306, US

(73) Assignee: Clean Coal Energy, LLC

(21) Appl. No.: 11/389,353

(22) Filed: Mar. 23, 2006

Related U.S. Application Data
(60) Provisional application No. 60/672,261, filed on Apr. 18, 2005.

(51) Int. Cl. H01M 8/12

(52) U.S. Cl. 429/30; 429/104; 429/31; 429/33; 429/13

(57) ABSTRACT

This invention discloses a method of converting carbon-containing materials directly to electrical energy without the need for intermediate processing steps. An embodiment comprises the use of a conductive molten medium with dispersed particles of carbon material as the anode in a fuel cell with a solid oxide electrolyte which enables conversion of carbon-containing materials (such as pulverized coal, charcoal, peat, coke, char, petroleum coke, oil sand, tar sand, waste plastics, biomass, and carbon produced by pyrolysis of carbonaceous substance) directly into electrical energy in a single step process. The anode optionally may have a dispersed second solid phase that getters CO2 and SO2 gases that are produced during the anodic reaction. Hence, this invention facilitates near-zero emissions and dramatically reduces the release of environmentally harmful emissions. More importantly, this direct route to electrical energy eliminates Carnot cycle constraints and offers high thermodynamic efficiency.

### RELATED APPLICATIONS

This application claims priority under 35 U.S.C. §119(e) to provisional application No. 60/672,261 filed on Apr. 18, 2005 titled “Direct Carbon Fuel Cell with Molten Anode.”

### FIELD OF THE INVENTION

This invention relates to the field of fuel cells, and in particular to the field of high temperature fuel cells for the direct electrochemical conversion of carbon to electrical energy. This invention is further directed to molten anodes in high temperature fuel cells.

### BACKGROUND OF THE INVENTION

Coal is a primary energy source with a high volumetric energy density of 27,000 MJ/m³ that offers a great advantage over natural gas (32 MJ/m³), biomass (1950 MJ/m³) and gaseous hydrogen (10.9 MJ/m³). Only liquefied fuels such as gasoline (31,000 MJ/m³), liquid propane (25,000 MJ/m³) and methanol (18,000 MJ/m³) offer such high volumetric energy densities, but, they are merely energy carriers (as opposed to being primary energy sources). In other words, they are produced from primary sources by expensive and inefficient processes.

Coal is also the most abundant and inexpensive primary energy source with sufficient reserves to meet the world's energy requirement for many decades, even centuries to come. For example, it is projected that proven coal reserves in the USA should last for more than 250 years.

Use of heat engines to convert the chemical energy of coal to useful work requires multiple processing steps that suffer from Carnot constraints that ultimately lower conversion efficiencies. Typically, coal fired power plant operate with efficiencies of 33-35%. However, direct electrochemical conversion of coal to electrical energy, which is the subject of this invention, is a single step process and is not subject to Carnot constraint and, hence, offers the possibility to achieve substantially higher efficiencies. For example, the theoretical value of the electrochemical conversion efficiency for the oxidation of carbon to carbon dioxide remains at about 100% even at elevated temperatures due to zero entropy change of the reaction. It is expected that practical conversion efficiencies of about 70% can be obtained for direct carbon conversion.

The earliest attempt to directly consume coal in a fuel cell was made long ago, by Becquerel in 1855 [K. R. Williams, in “An Introduction to Fuel Cells”, Elsevier Publishing Company, Amsterdam (1966), Chap. 1 ]. He used a carbon rod as the anode and platinum as the oxygen electrode in a fuel cell that employed molten potassium nitrate as the electrolyte. When oxygen was blown on to the Pt electrode a current was observed in the external circuit. However, his results were not encouraging because of the direct chemical oxidation of carbon by the potassium nitrate electrolyte.

Near the turn of the century, the goal “electricity direct from coal” was pursued with increasing vigor. An important achievement of this era was due to Jacques [W. W. Jacques, Harper's Magazine, 94,144 (December 1896-May 1897)] who used a molten sodium hydroxide electrolyte contained in an iron pot, which served as the air cathode, and a carbon rod as the consumable anode. The cell was operated at about 500° C. and current densities of over 100 ma/cm² were obtained at about 1 volt. He constructed a 1.5 kW battery consisting of over 100 of these cells and operated it intermittently for over six months. Unfortunately, Jacques did not give reliable information about cell characteristics and life of his battery. Haber and Brunner [F. Haber and L. Bruner, Z. Elektrochem., 10,697 (1904)] suggested that the electrochemical reaction at the anode in the Jacques cell was not the oxidation of carbon but of hydrogen that was produced, along with sodium carbonate, by the reaction of carbon with molten sodium hydroxide. Owing to this undesirable side reaction involving the electrolyte and rendering it unstable in that environment, Baur and co-workers [E. Baur, Z. Elektrochem., 16,300 (1910); E. Baur and H. Ehrenberg, Z. Elektrochem., 18, 1002 (1912); E. Baur, W. D. Treadwell and G. Trümpler, Z. Elektrochem., 27,199 (1921)] abandoned the molten alkali electrolytes and replaced them by molten salts such as carbonates, silicates and borates.

In 1937, Baur and Preis [E. Baur and H. Preis, Z. Elektrochem., 43,727 (1937)] suggested that the condition for a chemically stable electrolyte can only be met by the use of an ionically conducting solid electrolyte. For this purpose, they built a battery consisting of eight yttria stabilized zirconia electrolyte crucibles immersed in a common magnetite (i.e., Fe₃O₄) bath. The anode compartment was filled with coke and the cell was operated at about 1050° C. The open circuit battery potential was 0.83 volts, about 0.2 volts lower than that measured with single cells. At a cell voltage of about 0.65 volts the current density was about 0.3 mA/cm², too low for practical use. Furthermore, at these high operating temperatures, it is thermodynamically possible to carry out only partial oxidation of carbon, which would hence reduce the efficiency of the fuel cell significantly.

In the last several decades, high temperature fuel cells employing either molten carbonate or solid oxide ceramic electrolytes have been reported. In these cells, coal derived fuels [D. H. Archer and R. L. Zahradnik, Chem. Eng. Progr. Symp. Series, 63,55 (1967)], H₂ [J. Weissbart and R. Ruka, in “Fuel Cells”, Vol. 2, G. J. Young (ed.), Reinhold Publishing Corp., New York (1963)] and CH₄ [J. Weissbart and R. Ruka, J. Electrochem. Soc., 109,723 (1962)] were employed as consumable gaseous fuels. Presently, the high temperature solid oxide fuel cells under development in various laboratories around the world use either H₂ derived from natural gas by internal reforming in the cell, or H₂/CO mixtures derived from coal by an a priori gasification process.

### LITERATURE IN DIRECT CARBON CONVERSION

There are several publications and commercial development efforts that utilize some form of a molten medium in an attempt to generate electricity from carbon. The molten media that were employed consist of two categories, molten salts and molten metals, both of which serve to hold the carbon source.

Molten Salt Electrolyte Literature

Scientific Applications and Research Associates, Inc. (SARA) has been involved in developing a molten hydroxide fuel cell operating at 400-500° C. [www.sara.com/energy; “Carbon Air Fuel Cell” U.S. Pat. No. 6,200,697 (Mar. 3, 2001)]. The cell consists of a carbon anode surrounded by a molten hydroxide electrolyte. Air is forced over the metallic cathode where the reduction of oxygen generates hydroxide ions. The hydroxide ions are transported through the molten NaOH electrolyte to the anode where they react with the carbon anode releasing H₂O, CO₂ and These electrons travel through the external circuit to the cathode, and generate electricity.

Building upon the earlier work done at SRI International by Weaver and co-workers [R. D. Weaver, S. C. Leach, A. E. Bayce, and L. Nanis, “Direct Electrochemical Generation of Electricity from Coal”, SRI, Menlo Park, Calif. 94025; SAN-0115/105-1 (1979)] who employed a carbon anode in a molten carbonate electrolyte system for direct conversion of carbon to electricity, Lawrence Livermore National Laboratory [N. J. Cherepy, R. Krueger, K. J. Fiet, A. J. Jankowski, and J. F. Cooper, J. Electrochem. Soc. 152(1), A80 (2005); J. F. Cooper “Direct Conversion of Coal and Coal-Derived Carbon in Fuel Cells”, Second International Conference on Fuel Cell Science, Engineering and Technology, ASME, Rochester, N.Y., Jun. 14-16, 2004; “Fuel Cell Apparatus and Method Thereof”, U.S. Pat. No. 6,815,105 (Nov. 9, 2004)] has been developing a similar system which employs a molten carbonate electrolyte that holds nanosize carbon particles dispersed in it. The anode and cathode compartments are separated by a porous yttria stabilized zirconia (YSZ) matrix which serves to hold the molten electrolyte and allows transport of carbonate ions from the anode side to the cathode compartment. Suitable metals such as Ni are employed for anode and cathode materials. At the anode, dispersed carbon particles react with the carbonate ion to form CO₂ and electrons, while oxygen from air react with CO₂ at the cathode to generate carbonate ions. As the carbonate ions formed at the cathode migrate through the molten electrolyte towards the anode, the electrons liberated at the anode travel through the external circuit towards the cathode generating electricity.

Molten Anode Literature

Yentekakis and co-workers [I. V. Yentekakis, P. G. Debenedetti, and B. Costa, Ind. Eng. Chem. Res. 28, 1414 (1989)] proposed the concept for and simulated the expected performance of a direct carbon conversion fuel cell employing a molten Fe anode and a yttria stabilized zirconia (YSZ) solid electrolyte immersed in the molten anode. The operating temperature of the cell needs to be considerably higher than the melting point of Fe which is 1535° C. Indeed, their modeling was necessarily done for extremely high temperatures up to 2227° C. (or 2500 K). It was assumed that finely divided carbon particles are dispersed in the molten Fe anode. They suggested coating the cathode side of the YSZ electrolyte with a porous layer of Pt where the oxygen from the air would undergo a reduction reaction. The resulting oxide ions would be transported through the YSZ solid electrolyte towards the anode where they would emerge into the molten Fe bath and react with the dispersed carbon particles. The electrons released during this anodic reaction would travel in the external circuit generating electricity.

A similar approach has been pursued by CellTech Power, Inc. which recently patented [“Carbon-Oxygen Fuel Cell”, U.S. Pat. No. 6,692,861 B2 (Feb. 17, 2004)] a fuel cell that uses a carbon based anode. Their electrolyte can be chosen from a wide range of materials with melting temperatures from 300° C. to 2000° C. This would include molten electrolytes (such as molten carbonate) as well as solid oxide electrolytes (such as yttria stabilized zirconia). The latter would allow transport of oxygen ions generated from air at the cathode. Their web site portrays a direct conversion fuel cell [www.celltechpower.com] that employs molten Sn as anode and reports that the cell operates in a two-step process. During the first phase, the oxygen transported through the electrolyte oxidizes the molten Sn anode to SnO. In the second step, carbon fuel delivered into the anode compartment reduces the SnO back to metallic Sn, and the cycle is repeated.

The present invention is fundamentally different from these approaches. While the prior art employs electronically nonconducting molten salt electrolytes for transporting oxide ions in the form of either OH⁻ (hydroxide ions) or CO₃ ⁼ (carbonate ions), the present invention uses instead a solid, dense, and nonporous solid oxide ceramic electrolyte that selectively transports oxide ions in the form of O⁼ only So their ionic conduction mode and media are vastly different. Furthermore, the molten salt electrolytes employed in prior art do not transport electrons but only ions, unlike the electronically conducting molten anode employed in the present invention.

In addition, molten metal anodes employed in prior art all form oxide layers (e.g., SnO, SnO₂, FeO, Fe₂O₃, etc) at the anode surface that block the transport of oxide ions emerging from the solid electrolyte. They also impede electrons since these oxides are poor electronic conductors. In either case, the oxide layer formation at the anode is an impediment to oxide ion transport as well as the anodic charge transfer reaction.

The present invention, on the other hand, employs an electronically conducting molten anode that either is stable in oxygen environment and does not form oxides at the operating temperature of the cell, or in the case it may be oxidized, the resulting oxide is a good ionic conductor for oxygen ions so that the resulting oxide layer does not impede or block the transport of oxide ions emerging from the solid electrolyte into the molten anode. The molten anodes that are described in above-described art above all oxidize and form barrier layers that block the transport of oxide ions at the anode, while the present invention precludes and excludes the formation of an oxide ion blocking barrier layer in the first place.

More importantly, the present invention employs the carbon fuel for the sole purpose of oxidizing it while the above-described art uses the carbon fuel merely for the purpose of chemically reducing the resulting oxide barrier layer formed at the anode back to its metallic state in a two step process in order to operate their fuel cell.

### BACKGROUND ON PROPERTIES OF SOLID ELECTROLYTES

An important component of the disclosed direct coal fuel cell (DCFC) is the solid oxide electrolyte that facilitates oxide ion transport and supplies the oxygen for the oxidation of carbon and other reactants (such as hydrogen, sulfur etc) at the anode. Predominantly oxide-ion conducting solids have been known to exist for almost a century [W. Nernst, Z. Elektrochem., 6,41 (1900)]. Among these solids, zirconia-based electrolytes have widely been employed as electrolyte material for solid oxide fuel cells (SOFC).

Zirconium dioxide has three well-defined polymorphs, with monoclinic, tetragonal and cubic structures. The monoclinic phase is stable up to about 1100° C. and then transforms to the tetragonal phase. The cubic phase is stable above 2200° C. with a CaF₂ structure. The tetragonal-to-monoclinic phase transition is accompanied by a large molar volume (about 4%), which makes the practical use of pure zirconia impossible for high temperature refractory applications. However, addition of 8-15 m % of alkali or rare earth oxides (e.g., CaO, Y₂O₃, Sc₂O₃) stabilizes the high temperature cubic fluorite phase to room temperature and eliminates the undesirable tetragonal-to monoclinic phase transition at around 1100° C. The dopant cations substitute for the zirconium sites in the structure. When divalent or trivalent dopants replace the tetravalent zirconium, a large concentration of oxygen vacancies is generated to preserve the charge neutrality of the crystal. It is these oxygen vacancies that are responsible for the high ionic conductivity exhibited by these solid solutions. These materials also exhibit high activation energy for conduction [T. M. Gür, I. D. Raistrick and R. A. Huggins, Mat. Sci. Engr., 46, 53 (1980); T. M. Gür, I. D. Raistrick and R. A. Huggins, Solid State Ionics, 1, 251 (1980)] that necessitates elevated temperatures in order to provide sufficient ionic transport rates. The electronic contribution to the total conductivity is several orders of magnitude lower than the ionic component at these temperatures. Hence, these materials can be employed as solid electrolytes in high temperature electrochemical cells.

The usefulness of solid oxide electrolytes is based on two important features. First, the chemical potential difference of oxygen across the electrolyte is a measure of the open circuit potential via the Nernst Equation,
E=−(RT/nF)1n(PO₂′/PO₂^{″}) (1)
where E is the equilibrium potential of the cell under open circuit conditions, R is the gas constant, F is Faraday's constant, n is the number of electrons per mole (in the case of O₂, n=4), and PO₂ denotes the partial pressure of oxygen. Hence the electrolyte can serve as a static oxygen sensor. Secondly, the electrical charge passed through the electrolyte is carried directly by oxide ions. Hence, stabilized zirconia can be used as an electrochemical transducer involving oxygen transport.

### BRIEF DESCRIPTION OF THE DRAWINGS

FIG. 1 shows the theoretical conversion efficiency and the expected open circuit voltage as a function of temperature for the electrochemical oxidation reaction of carbon. Note the temperature independence of E and efficiency for the carbon oxidation reaction, while the behavior is strongly dependent on temperature for the case of hydrogen.

FIG. 2. Schematic design of a direct coal conversion fuel cell featuring a molten metal anode charged with carbon fuel and CO₂/SO₂ sequestering agent.

FIG. 3. Schematic design of a shell-and-tube type direct coal conversion fuel cell with cathodes on internal surfaces of tubes, and featuring a molten metal anode charged with carbon fuel and CO₂/SO₂ sequestering agent. For brevity, electrical lead connections to only one cell are illustrated.

FIG. 4. Schematic design of a shell-and-tube type direct coal conversion fuel cell with cathodes on outside surfaces of tubes, and featuring a molten metal anode charged with carbon fuel and CO₂/SO₂ sequestering agent. For brevity, electrical lead connections to only one cell are illustrated.

### SUMMARY OF THE INVENTION

The invention is directed to a fuel cell for the direct conversion of a carbon-containing fuel into electricity. The fuel cell has an anode which has a carbon-containing fuel dispersed in a bath of a electronically-conducting molten metal. In a preferred embodiment, the molten metal does not form stable oxides under the conditions of operation. The fuel cell has a solid oxide electrolyte. In one embodiment, the solid oxide electrolyte is in the form of a one-end closed tube. Other geometries of the solid electrolyte are within the scope of this invention. In one embodiment of the one-end closed tube version, the one-end closed tube comprises an inside tube surface and an outside tube surface, such that a portion of the outside tube surface is dipped into the bath of the molten metal, and there is a cathode material coating a portion of the inside tube surface of the solid oxide electrolyte. In the fuel cell, electrical current is electrochemically generated by mass transport of oxygen across the solid oxide electrolyte for oxidation of the carbon-containing fuel in the anode after a phase comprising oxygen is brought into contact with a surface of the solid electrolyte. Air is an example of a phase comprising oxygen.

### DETAILED DESCRIPTION OF THE INVENTION

The electrochemical conversion of carbon into electricity is achieved in a high temperature fuel cell that features an oxide ion selective solid electrolyte that supplies the oxygen required for the electrochemical oxidation of coal. Carbon fuel in all natural and synthetic forms of carbon including but not limited to coal (including anthracite, bituminous, subbituminous, and lignite coals), char, peat, coke, petroleum coke, tar sand, oil sand, charcoal, waste plastic, carbon produced by pyrolysis of carbonaceous substance, and biomass is introduced into the anode compartment of the cell as solid fuel with or without a priori physical and chemical treatment (e.g., de-ashing, washing, cleaning, and desulfurization). Furthermore, the carbon fuel is introduced into the anode compartment of the cell with or without other solid constituents, such as sequestering agents for capturing the CO₂ and SO₂ produced.

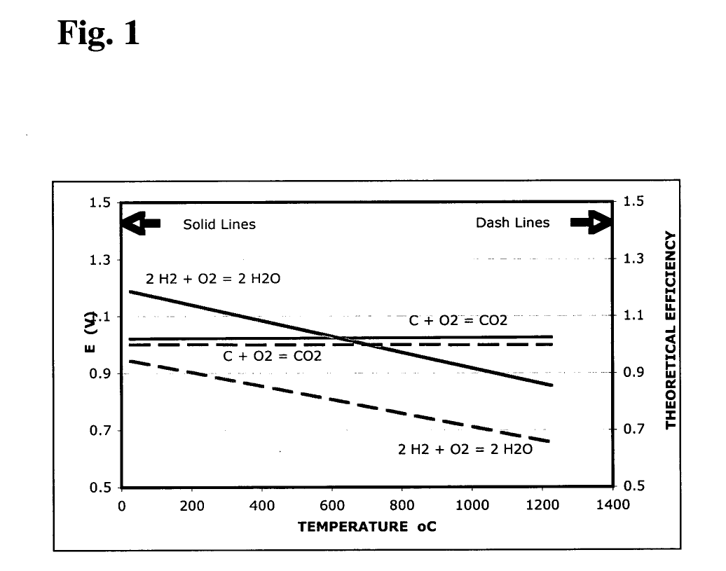

Referring to Eq. (1), the open circuit voltage of the fuel cell is determined by the carbon-oxygen equilibrium at the anode, since the oxygen activity on the cathode side is fixed by air. FIG. 1 shows the theoretical conversion efficiency and the expected open circuit voltage as a function of temperature for the electrochemical oxidation reaction of carbon. The figure also compares the carbon-oxygen couple with that for hydrogen, which shows strong temperature dependence. In other words, a solid oxide fuel cell (SOFC) using hydrogen as fuel and operating at high temperatures will have significantly lower open circuit voltage as well as theoretical efficiency than one that employs carbon as fuel. This is primarily because the entropy change during carbon oxidation is negligibly small, and the Gibbs free energy for carbon oxidation is nearly independent of temperature. The situation is different for the oxidation of hydrogen, which exhibits a strongly negative temperature dependence. Moreover, for hydrogen to be employed as fuel, it needs to be produced from other resources first, while carbon is an abundant and cheap source of energy that is readily available. So there is a great incentive to employ the carbon-oxygen couple. Indeed, FIG. 1 clearly indicates 100% theoretical efficiency and slightly over 1 volt open circuit voltage, both of which are practically independent of temperature over the entire useful range.

The preferred embodiments for the molten metal bath are several:
The molten or eutectic anode is desirably a good electronic conductor and possesses a suitable melting temperature that is appropriate for the preferred operating temperature of the fuel cell which is from 250° C. to 1300° C.
It is desirable to choose the metal or alloy from those that are stable in the presence of oxygen at the anode and not form a stable oxide at the fuel cell operating temperature. A good example of this type of metal is silver which does not have a stable oxide above 230° C. So in the elevated operating temperatures of the DCFC cell it will retain its metallic character and will not form an oxide.
If the molten metal or alloy does form an oxide, it is desirable that this oxide is not blocking to the transport of oxygen ions, i.e., that this oxide itself is a good conductor of oxide ions. A good example of this is bismuth whose oxide is known to be an excellent conductor of oxide ions. So even in the case an oxide layer forms at the anode side of the solid electrolyte, the resulting oxide by virtue of its selective permeability to oxide ions does not pose an impediment for their transport from the solid electrolyte into the anode compartment.
The solubility of oxygen in this molten metal or eutectic anode should be sufficiently high to allow high throughput. The high solubility of oxygen in the molten bath facilitates larger concentrations of oxygen available for the oxidation reaction with the carbon.
The diffusion coefficient of oxygen in the molten metal or eutectic anode should also be sufficiently high for the fuel cell to operate at high current densities. This of course translates into high power densities for the fuel cell.
The molten metal or eutectic anode should be stable with respect to carbon, hydrogen, and nitrogen, and does not form stable carbides, hydrides, and nitrides.

The molten bath contains the dispersion of carbon fuel particles along with a second type of solid particles, which are selected from the group consisting of magnesium silicates, CaO and MgO and their mixtures for the capture of CO₂ and SO₂. The term magnesium silicates encompasses materials such as serpentine, olivine, and talc.

The direct coal fuel cell disclosed here requires that one surface of the solid oxide electrolyte (such as YSZ) is in contact with molten metal bath that contains the carbon fuel and also serves as the anode, while the other surface which serves as the cathode is in contact with an oxygen source, such as ambient air, or pure oxygen to furnish the oxygen needed for the oxidation reaction at the anode. The solid oxide electrolyte serves as a selective membrane for transporting oxygen ions from the air side cathode to the molten bath anode where it reacts with the carbon particles to produce electricity.

Many geometries, structures, and arrangements of the solid oxide electrolyte within the fuel cell are within the scope of this invention. In one embodiment, the solid oxide electrolyte is as a thin layer coated onto a porous cathode, which porous cathode optionally provides mechanical support for the thin layer of solid oxide electrolyte. Preferably, the layer of solid oxide electrolyte has a thickness of 1 to 100 microns. The geometry of this configuration could be in the form of a tube, a flat plate, or a corrugated plate. In the figures, examples are presented of embodiments employing tubes. However, these examples are non-limiting. Geometries other than tubes may be employed. Further, within the tube geometry, the tube shape may be comprised primarily of solid electrolyte or it may be comprised of a coating of solid electrolyte on another substrate.

One surface of the YSZ tube is coated with a suitable cathode material, where, using Kroger-Vink defect notation, the electrochemical reduction of oxygen takes place as follows:
O_{2(g)}+2Vₒ^{\ddot{}}_{(YSZ)}+4e′_{(electrode)}=2Oₒ^{x}_{(YSZ)} (2)

While the oxygen vacancies, Vₒ^{\ddot{}}_{(YSZ)}, migrate under the influence of the concentration gradient through the YSZ solid electrolyte from the anode to the cathode, oxygen ions are transported in the reverse direction from the cathode to the anode where they participate in the electrochemical oxidation of carbon.
C_{(Ag)}+2Oₒ^{x}_{(YSZ)}=CO_{2(g)}+2Vₒ^{\ddot{}}_{(YSZ)}+4e′_{(electrode)} (3)

The electrons that are released during the oxidation reaction at the anode travel through the external circuit towards the cathode, producing useful electricity. The oxygen chemical potential difference between the anode and the cathode (i.e., air) provides nearly 1 volt open circuit voltage at about 1000° C.

YSZ is the preferred the solid electrolyte. However, scandia stabilized zirconia has a higher conductivity than its yttria counterpart [T. M. Gür, I. D. Raistrick and R. A. Huggins, Mat. Sci. Engr., 46, 53 (1980)]. Also, it is possible to employ tetragonal zirconia which is known to possess higher conductivity and better thermal shock resistance than cubic zirconia electrolytes.

Other solid electrolytes that exhibit selective oxygen conduction are also suitable for the disclosed DCFC system. These include solid solutions of alkali or rare earth oxides with thoria (i.e., ThO₂), hafnia (i.e., HfO₂), and ceria (e.g., CeO₂—Gd₂O₃) of the fluorite structure, the pyrochlore structure oxides as well as ionically conducting perovskites such as doped gallates (e.g., LaGaO₃), and hexagonal structure apatites, giving a wide ranging choice of structures.

The concept of molten metal bath (or an electronically conductive metal oxide molten or eutectic bath) is ideally suited not only to make good electrical contact with the YSZ tube, but also to contain and disperse both the carbon source (coal, char, peat, coke, biomass, etc) and the CO₂ and SO₂ gettering solid phase.

The preferred choice for the molten metal bath is silver for several important reasons. Its melting point of 960° C. is ideally suited for the efficient operating regime of solid oxide fuel cells (SOFC). Silver also is the metal with one of the highest dissolved oxygen concentrations at any temperature. Furthermore, the diffusion coefficient of oxygen in Ag is the highest in any metal, and is measured to be 1.5×10⁻⁵ cm²/s at 700° C. [S. Sinde, K. Nisancioglu, and T. M. Gür, J. Electrochem. Soc. 143(#11), 3497-3504 (1996)]. Silver is also an excellent electronic conductor with good wetting capability for the YSZ surface.

Equally important is the fact that Ag does not form stable oxides at the elevated temperatures employed for solid oxide fuel cells. The only stable oxide of silver, Ag₂O is unstable above 230° C. Hence, the problems of oxide formation at the anode is eliminated when Ag is used for the molten anode. This is a critically important advantage in order to maintain a stable and coherent interface between the ionically conducting solid electrolyte and the molten Ag anode. Otherwise, any reaction product forming at this interface has the potential of impeding or blocking the charge transfer reaction at the anode, ultimately increasing anodic polarization and degrading the fuel cell efficiency. In short, the use of Ag as the molten anode eliminates the possibility of these deleterious effects.

Another virtue of Ag that is of interest to this invention is that it does not react with carbon, and does not form a carbide phase. So the carbon fuel can safely and easily be distributed and dispersed into the molten Ag bath without degradation or loss to undesirable chemical reactions.

Similarly, Bi is an excellent example of a molten anode that tends to form an oxide that is ionically conducting to oxide ions and hence does not pose impediment to the transport of oxide ions. In fact, the cubic phase of Bi₂O₃ is an intrinsic oxide ion conductor with very high ionic conductivity for oxygen. Bismuth also has a suitable melting point of 271° C. and its oxides are unstable above 860° C. and decompose. It also has excellent electronic conductivity and serve well as a current collector. Furthermore, it does not form carbides and nitrides. Its sulfide Bi₂S₃ decomposes at 685° C., so does not exist at the elevated operating temperature of the fuel cell.

If it is desired to sequester the carbon dioxide (or sulfur dioxide) that is formed at the anode during the oxidation process, the Ag bath can be loaded with a gettering agent (such as magnesium silicate, CaO, MgO, or their mixtures) that captures the evolving CO₂ and SO₂ gases and convert them into insoluble and inert solid carbonates and sulfates (i.e., CaCO₃ and CaSO₄) that are recovered or separated from the bath. So this Direct Coal Fuel Cell (DCFC) is not only capable of operating with high efficiency inherent to SOFCs but also can be equipped to release practically no emissions.

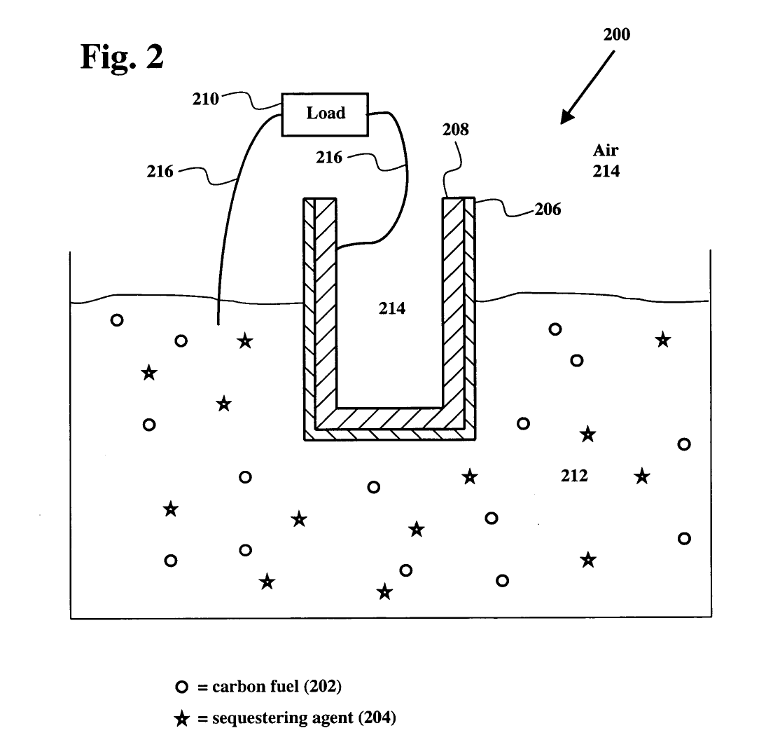

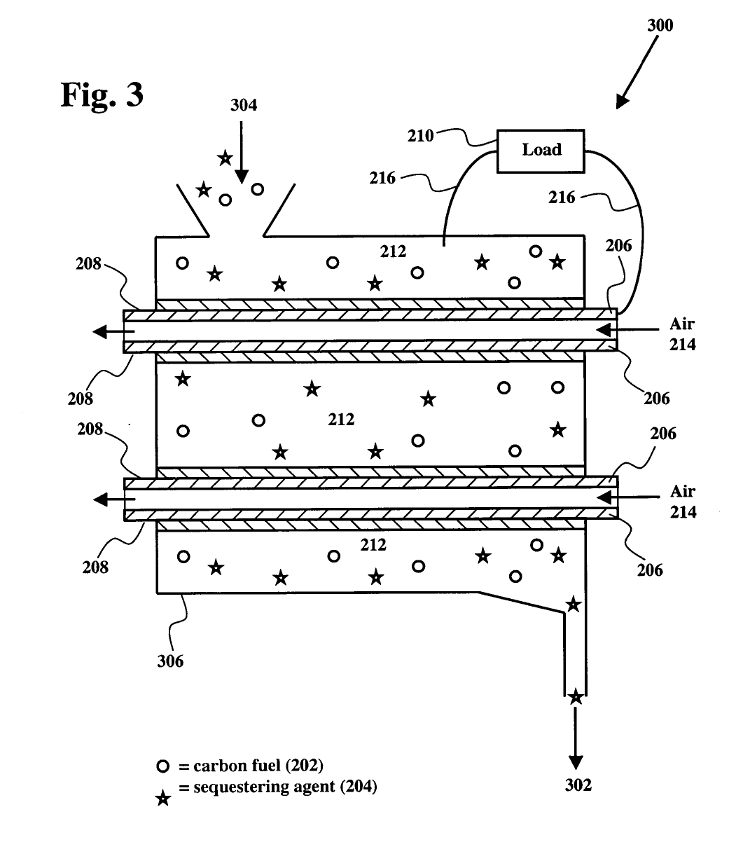

One embodiment of the DCFC employs one-end closed solid oxide electrolyte tubes that are dipped into the molten anode bath such that the closed end of the tubes are in direct contact with the molten bath which contain a dispersion of carbon fuel particles as well as a suitable sequestering agent for CO₂/SO₂ capture. FIG. 2 shows the schematic design of this system. In another embodiment, open-ended solid oxide electrolyte tubes are stacked in a shell-and-tube geometry and supported by the end plates of the shell as depicted in FIG. 3. The external surfaces of the tubes are in direct contact with the molten anode bath containing a proper dispersion of the carbon source and the CO₂/SO₂ gettering agent.

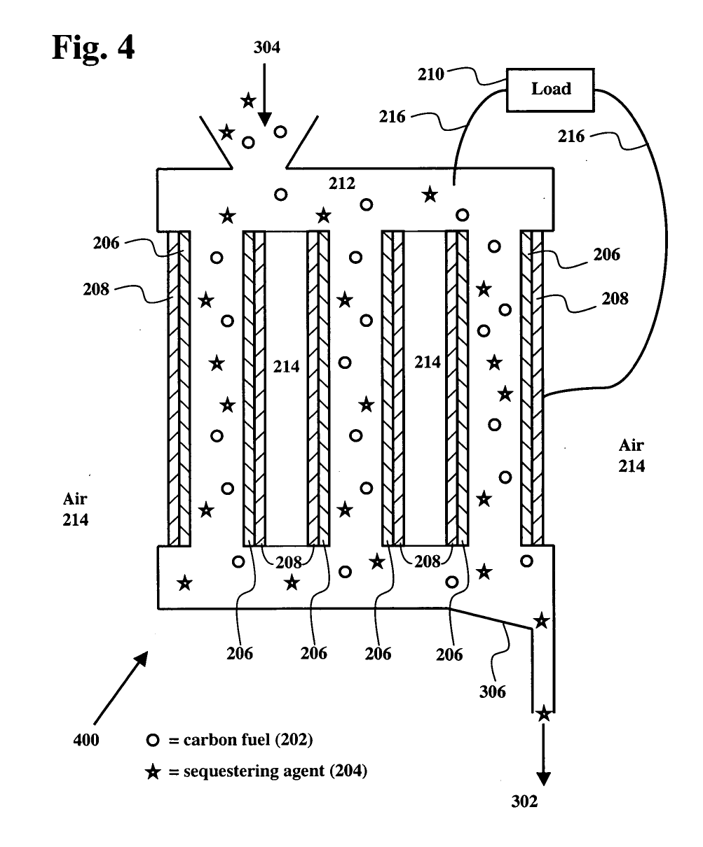

In another embodiment, the molten anode containing the carbon particles and the CO₂/SO₂ gettering agent reside inside the open-ended solid oxide electrolyte tubes. In this configuration, illustrated in FIG. 4, the anode is located inside the tubes, while the cathode is located at the external surface of the tubes.

Yet another embodiment of this technology is the fact that it can employ other suitable molten baths such as eutectics of metallically conducting oxides.

Each of these individual DCFC configurations generates valuable waste heat at high temperatures that may be used for process heating or steam generation to drive a turbine and increase the system efficiency of the overall process. This combined gas cycle operation has the added advantage of using the waste heat from the turbine for heating up the makeup air for the cathode.

FIG. 2 shows an example of a cross-sectional view of a molten anode fuel cell. The fuel cell 200 includes a cathode 208, a solid oxide electrolyte 206, a molten anode 212, a load 210 to be driven by the fuel cell 200, and electrodes 216 that connect the cathode 208, anode 212, and load 210 together. Also shown is air 214. The molten anode includes a carbon fuel 202 and, optionally, a sequestering agent 204. The example in FIG. 2 shows a kind of open tube or open box half dipped in a tank of molten anode. Actual implementation may be easier with more containment.

FIG. 3 shows an example of a cross-sectional view of a molten anode fuel cell with air flowing through tubes. The fuel cell 300 includes a cathode 208, a solid oxide electrolyte 206, a molten anode 212, input fuel 304 (comprising carbon fuel 202 and optional sequestering agent 204), molten anode containment 306, and a spent sequestering agent output 302. Also shown is air 214 moving through tubes of electrolyte 206. The molten anode includes a carbon fuel 202 and, optionally, a sequestering agent 204. Also shown are a cathode 208 (which is in between the electrolyte 206 and air 214), a load 210 to be driven by the fuel cell 300, and electrodes 216 that connect the cathode 208, anode 212, and load 210 together. For clarity, electrical lead connections to only one cell are illustrated. In this example air flows through the tubes to provide the oxygen to the fuel cell 300. Of course, it is also possible to have the molten anode flow through the tubes as well.

FIG. 4 shows an example of a molten anode fuel cell with a molten anode in tubes. The fuel cell 400 includes a cathode 208, a solid oxide electrolyte 206, a molten anode 212, input fuel 304 (comprising carbon fuel 202 and optional sequestering agent 204), molten anode containment 306, and a spent sequestering agent output 302. Also shown is the molten anode 212 in tubes of electrolyte 206, the tubes being surrounded by air 214. The molten anode includes a carbon fuel 202 and, optionally, a sequestering agent 204. Also shown are a cathode 208 (which is in between the electrolyte 206 and air 214), a load 210 to be driven by the fuel cell 400, and electrodes 216 that connect the cathode 208, anode 212, and load 210 together. For clarity, electrical lead connections to only one cell are illustrated. In this example air flows around he outside of the tubes to provide the oxygen to the fuel cell 400.

The present invention offers the following advantages over the prior art.
Offers a theoretical conversion efficiency of 100%
Offers reduced emissions per unit of electricity generated
Offers reduced consumption of carbon fuel per unit of electricity generated
Uses coal directly, rather than intermediate conversion of coal to gaseous products such as CO and H₂
Offers one step process for direct conversion of coal to electrical energy
Eliminates Carnot cycle limitations related to converting chemical energy into electricity
Does not combust coal, but oxidizes it
Converts coal to electricity without the use of large quantities of water in contrast to the current technologies employed in coal-fired power plants
Utilizes a solid oxide electrolyte to supply the oxygen for the electrochemical oxidation of coal
Offers practical high conversion efficiency
Does not require a priori chemical treatment of coal for removal of ash or desulfurization
Eliminates need for a priori gasification of coal in order to be able to use it in a fuel cell
Insensitive to the source of carbon and quality of coal
Uses sulfur tolerant anode material
Produces highly concentrated (85-95% CO₂) flue gas that enables easy capturing and sequestration of the carbon dioxide.
Single source collection of CO₂
Provides environmentally friendly solution to coal utilization for energy generation
Offers potentially near-zero emissions
   Embodiments of the molten anode of the present invention are derived from the following characteristics:
The molten anode should be an electronic conductor.
The molten anode should have a melting point that lies within 250° C.-1300° C.
Preferably, the molten anode should not form a stable oxide within this temperature regime.
If the molten anode does form a stable oxide layer that block oxide ions, the oxide should not be thermodynamically at the operating temperature of the fuel cell.
If the molten anode forms a stable oxide under operating conditions, the resulting oxide should possess selective ionic conductivity for the oxide ion.
The molten anode should not form a stable carbide within this temperature regime.
The molten anode should exhibit high solubility for oxygen within this temperature regime.
The molten anode should exhibit high diffusion coefficient for oxygen transport within this temperature regime.

What is claimed is:

1. A fuel cell comprising:
an anode compartment comprising an electronically-conducting molten anode and a carbon-containing fuel,
a solid oxide electrolyte that selectively transports oxide ions, and
a cathode,
where electrical current is generated by oxidation of the carbon-containing fuel in the anode compartment.

2. The fuel cell of claim 1, where the electronically-conducting molten anode comprises silver.

3. The fuel cell of claim 1, where the carbon-containing fuel is selected from the group consisting of pulverized coal, charcoal, peat, coke, char, petroleum coke, oil sand, tar sand, waste plastics, biomass, and carbon produced by pyrolysis of carbonaceous substance.

4. The fuel cell of claim 1, where the anode compartment further comprises a solid which captures CO2.

5. The fuel cell of claim 1, where the anode compartment further comprises a material selected from the group consisting of calcium oxide, magnesium oxide, dolomite, olivine, serpentine, talc, mica, clay, and zeolite.

6. The fuel cell of claim 1, where the solid oxide electrolyte is in the form of a tube, the tube comprising an inside tube surface and an outside tube surface, where a portion of the outside tube surface is in contact with the bath of a molten metal,
where the cathode coats at least a portion of the inside tube surface of the solid oxide electrolyte, and
where electrical current is electrochemically generated by mass transport of oxygen across the solid oxide electrolyte for oxidation of the carbon-containing fuel in the anode when oxygen is brought into contact with the inside tube surface of the solid electrolyte.

7. The fuel cell of claim 1, where the solid oxide electrolyte is in the form of a tube, the tube comprising an inside tube surface and an outside tube surface, where a portion of the inside tube surface is in contact with the bath of a molten metal,
where the cathode coats at least a portion of the outside tube surface of the solid oxide electrolyte, and
where electrical current is generated by the oxidation of the carbon-containing fuel in the anode compartment when oxygen is brought into contact with the outside tube surface of the solid electrolyte.

8. The fuel cell of claim 1, where the solid oxide electrolyte is a thin layer coated onto a the cathode,
where the cathode is porous, and
where the layer of solid oxide electrolyte has a thickness of 1 to 100 microns.

9. The fuel cell of claim 1, where the solid oxide electrolyte is selected from the group consisting of the oxides of Hf, Zr, Y, Sc, Yb, La, Ga, Gd, Bi, Ce, and Th, where the oxides are doped with oxides from the group consisting of alkaline earth metals and rare earth metals.

10. The fuel cell of claim 1, where the solid oxide electrolyte comprises oxides selected from the group consisting of zirconium oxide, thorium oxide, hafnium oxide, scandium oxide, yttrium oxide, gadolinium oxide, ytterbium oxide, lanthanum oxide, gallium oxide, and cerium oxide, optionally stabilized by other oxides.

11. The fuel cell of claim 1, where the solid oxide electrolyte is zirconium oxide doped with yttrium oxide.

12. The fuel cell of claim 1, where the molten metal comprises bismuth.

13. The fuel cell of claim 1, where the anode further comprises a material selected from the group consisting of serpentine, olivine, talc, dolomite, mica, clay, and zeolite.

14. The fuel cell of claim 1, where the molten anode comprises a molten metal bath, where the metal does not form a stable oxide under conditions of operation.

15. The fuel cell of claim 14, where the molten metal bath comprises bismuth.

16. The fuel cell of claim 1, where the molten anode comprises a molten metal bath, where the metal forms an oxide which is a good conductor of oxygen anions.

17. A method for electrochemically oxidizing a carbon-containing fuel in a fuel cell, comprising the steps of:
combining the carbon-containing fuel in a bath of molten metal to form an anode compartment in the fuel cell,
contacting the anode compartment with a solid oxide electrolyte,
contacting a cathode material onto the solid oxide electrolyte, and
generating an electrical current by bringing oxygen into contact with the solid oxide electrolyte.

18. The method of claim 17, where the metal does not form stable oxides under the conditions of operation of the fuel cell.

19. The method of claim 17, where the metal comprises silver.

20. The method of claim 17, where the metal forms oxides which conduct oxygen anions under the conditions of operation of the fuel cell.

21. The method of claim 17, where the metal comprises bismuth.

22. The method of claim 17, where the metal does not form a stable oxide within the temperature range 250° C.-1300° C.

23. The method of claim 17, where the metal has a melting point that lies within the range 250° C.-1300° C.

24. The method of claim 17, where the metal does form an oxide within the temperature range 250° C.-1300° C. and the oxide is thermodynamically unstable at the temperature of operation of the fuel cell.

25. The method of claim 17, where the metal forms a stable oxide in the range 250° C.-1300° C. and the oxide possesses selective ionic conductivity for the oxide ion.

26. The method of claim 17, where the metal does not form a stable carbide within the temperature range 250° C.-1300° C.

27. The method of claim 17, where the metal exhibits high solubility of oxygen within the temperature range 250° C.-1300° C.

28. The method of claim 17, where the metal exhibits a high diffusion coefficient for oxygen transport within the temperature range 250° C.-1300° C.

29. The method of claim 17, where the metal does not form a stable carbide under the operating conditions of the fuel cell.

30. The method of claim 17, where the metal exhibits a high solubility of oxygen under the operating conditions of the fuel cell.

31. The method of claim 17, where the metal exhibits a high diffusion coefficient for oxygen transport under the operating conditions of the fuel cell.
